(19) United States
(12) Patent Application Publication
(10) Pub. No.: US 2023/0097047 A1
(43) Pub. Date: Mar. 30, 2023

(54) SALTY YOGHURT OR YOGHURT-LIKE PRODUCT AND PROCESS

(71) Applicant: Arla Foods amba, Viby J (DK)

(72) Inventors: Sander Sieuwerts, Skanderborg (DK); Saeed Rahimi Yazdi, Mårslet (DK)

(21) Appl. No.: 17/595,550

(22) PCT Filed: Jun. 25, 2020
(86) PCT No.: PCT/EP2020/067853

§ 371 Date: Nov. 18, 2021

(30) Foreign Application Priority Data
Jun. 28, 2019 (EP) 19183162.7

(51) Int. Cl. A23C 9/123; A23C 21/06; A23C 9/142; A23C 17/02

(52) U.S. Cl. CPC A23C 9/1234; A23C 9/142; A23C 17/02; A23C 21/06; A23C 2210/202

(57) ABSTRACT

A method for producing a salty yoghurt or yoghurt-like product comprising combining buttermilk, and milk permeate and optionally whey is hereby provided. Additionally, a salty yoghurt or yoghurt-like product comprising buttermilk, milk permeate and optionally whey is also provided. Finally, a yoghurt powder base composition comprising the components in a dry form is also provided.

### TECHNICAL FIELD

In the present disclosure, dairy side-streams are balanced to make a base for the production of a salty yoghurt or yoghurt-like product without using any other main ingredients than dairy side-streams (salt and liquid not considered) and without performing any additional steps of preparation to the side-streams.

### BACKGROUND

From the production of dairy products, there are many side-streams (also referred to as by-products) that currently have little to no commercial value. These side-streams are often not used in dairy products or ingredients. These side-streams are generally sold as low value ingredients to the animal feed industry, combusted in biogas plants or treated as waste even though some of them have good nutritional properties and may have good commercial value. Examples of such side-streams include sweet buttermilk (SBM or SBMP if in powder form, originating from butter production), acid whey (AW, originating from e.g. skyr production) and milk permeate concentrate (MPC, originating from a filtering process in which milk proteins are removed and the liquid containing lactose is concentrated).

The traditional Ayran yoghurt salty drink normally comprises yoghurt (60%), water, whey, and salt (0,7%). The standard process for making this is by standardized milk (3,5% fat) followed by homogenization and pasteurization, after which fermentation is performed with a yoghurt culture. Finally, the Ayran yoghurt is mixed with water and salt and/or whey, smoothened and filled into containers.

The traditional production of Ayran requires the usage of milk and thereby adds to the global demand for milk. Furthermore, the traditional Ayran yoghurt salty drink is made from 3.5 fat% milk and therefore can make a significant contribution to the intake of animal fat.

### SUMMARY OF THE DISCLOSURE

The current disclosure provides a salty yoghurt or yoghurt-like product and a method of producing it, where the method comprises combining sweet buttermilk, and milk permeate. These may be obtained from side-streams. Acid whey may be added as an additional side-stream.

The product may be a drink or a spoonable product.

In a first aspect, the salty yoghurt or yoghurt-like product is intended as a dairy product with a distinct salty taste, which is at least partially liquid so that it can be ingested by drinking.

In one aspect, a method is provided for producing a salty yoghurt product, said method comprising combining sweet buttermilk, and milk permeate. Acid whey may be added to increase the acidity and to balance the sweetness of the product.

In another aspect, a salty yoghurt or yoghurt-like product is provided, which is obtainable by the process defined in the aspect above.

In a further aspect, a salty yoghurt or yoghurt-like product is provided, which comprises sweet buttermilk, and milk permeate. The composition may further comprise acid whey.

In an additional aspect, a yoghurt powder base composition comprising the sweet buttermilk and milk permeate in a dry form is provided.

Advantages of the new production process compared to the standard processes are (i) valorisation of side-streams, (ii) a leaner process, (iii) a safer process with respect to microbiological product quality and (iv) a faster process. A further advantage is that the product can be prepared from dry side-streams and therefore as a dry product which can be shipped to a dairy for mixture with liquid, optional fermentation and pasteurization and packaging. This may result in considerable savings on transportation costs.

The present disclosure provides a utility of milk permeate concentrate to produce novel dairy products. Milk permeate concentrate (MPC) comprises the soluble parts of milk after the majority of milk fat and protein have been removed. MPC contains more lactose and is therefore sweeter than milk. MPC also contains a relatively high amount of salt. This means that only a minor amount of salt — if any — is added to the yoghurt or yoghurt-like products of the present disclosure in order to achieve a product with the distinct salty and acid flavour of traditional Ayran drink.

Acidity can be imparted on the yoghurt or yoghurt-like products by adding acid whey or by fermenting with an acidifying yoghurt or kefir culture. In this way the sweetness, saltiness, and acidity can be balanced and a product with similar taste characteristics as traditional Ayran drink can be obtained.

One important difference to traditional Aryan drink is the lower content of milk fat in the final product. The products are therefore low-fat alternatives to existing salty yoghurt drinks.

The valorisation of side-streams leads to a lower environmental burden (and a lower financial burden for the producer) i.e. fractions that were considered non-useful, but still contributed to the total carbon footprint per litre of processed milk, can now end up as consumer products. The new production method also circumvents the addition of ingredients post-fermentation, which makes the whole process leaner, shorter and less complex. Additionally, the circumvention of adding ingredients post-fermentation results in a microbiologically more stable product.

Furthermore, in the new production process all ingredients can be pasteurized which, comparably to the standard (traditional) process of adding non-pasteurized ingredients, gives a decreased risk of spoilage. When acid whey is not present, the product can be pasteurized at a higher temperature, such as at temperatures above 85° C.

By combining the side-streams into a salty yoghurt or yoghurt-like product as herein described, a salty yoghurt or yoghurt-like product with similar taste but with a lower fat content than traditional Ayran can be obtained (Table 4).

Finally, the addition of acid whey gives a lower initial pH, which means that the fermentation time may be shorter. This is exemplified in FIG. 3.

### DESCRIPTION OF DRAWINGS

FIG. 1. The standard process for making Ayran according to the recipe for Arla’s Bizim Ayran.

FIG. 2. The process for making Ayran based on the side-streams sweet buttermilk (SBM), sweet buttermilk powder (SBMP), acid whey (AW) and milk permeate concentrate (MPC).

FIG. 3. Typical acidification curves for fermentations at 43° C. using the processes as described in Examples 1 (No. 1 , including acid whey), 4 (No. 2, excluding acid whey) and 5 (No. 3, excluding acid whey, fermentation with kefir culture).

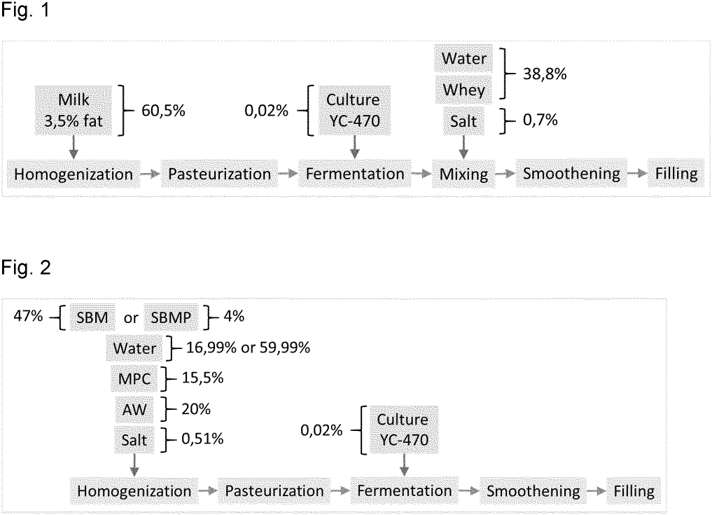

### DETAILED DESCRIPTION

### Method of Producing a Salty Yoghurt or Yoghurt-Like Product

A main aspect of the present disclosure relates to a method of producing a salty yoghurt or yoghurt-like product, wherein sweet buttermilk, and milk permeate are combined. In a preferred embodiment, acid whey is also added.

The below described methods lead to the production of a salty yoghurt or yoghurt-like product. The product is sour and salty and has the taste of traditional Ayran-drink. The acidity can come from the acid whey component or from a fermentation culture added to the product. Even without fermentation, the product tastes like yoghurt and is therefore a yoghurt-like product.

A yoghurt-like product is defined as a product resembling a yoghurt product in texture and taste, but which is not fermented with the yoghurt starter cultures Streptococcus thermophilus and Lactobacillus delbruekii subsp. Bulgaricus. A yoghurt-like product can be fermented with different cultures such as kefir grains, Acidophilus or Bifidobacteria, or it can be soured, thus being unfermented.Unfermented yoghurt-like products can obtain a low pH by souring by different acid solutions not containing cultures, such as acid whey, lactic acid or other food compatible acids.

A method can comprise the usage of side-streams by
a. Obtaining side-streams originating from production of butter, cottage cheese, skyr and/or strained yoghurt using raw milk,
b. thereby obtaining side-streams comprising milk permeate, sweet buttermilk (liquid or powder) and optionally acid whey,
c. mixing said above ingredients with a liquid and a salt to obtain a yoghurt product base.

Another method can comprise the usage of raw milk by
a. Obtaining raw milk,
b. Separating the different milk components, thereby obtaining milk permeate, sweet buttermilk (liquid or powder) and optionally acid whey,
c. mixing milk permeate and sweet buttermilk and optionally acid whey to obtain a yoghurt product base.

The salty yoghurt product can be made in several ways by including different amounts of the side-streams, salt and liquid. However, a general method includes mixing the side-streams milk permeate, sweet buttermilk (liquid or powder) and optionally acid whey with liquid and salt to obtain a yoghurt product base. After homogenisation and pasteurisation, the base may be fermented with a yoghurt culture and subsequently smoothened and filled to obtain a final salty yoghurt or yoghurt-like product.

Because of the acidity of acid whey, the addition of dairy protein to an acid whey fraction (for example by mixing AW and SBM or SBMP) may result in direct coagulation of the protein and thereby a graininess in the final product. Therefore, it is preferred to mix in acid whey as the last fraction.

Additionally, protein under acidic conditions is more likely to coagulate when the base is heated for pasteurization. This can be solved by using mild pasteurization conditions using lower temperatures for a longer duration instead of high temperatures and a short duration normally used for yoghurt and yoghurt-like products in combination with homogenization before pasteurization. Examples of mild pasteurization conditions are at above 70° C., such as 70-75° C. for 5-30 minutes, for example 10-20 minutes.

When acid whey is not part of the compositions of the disclosure, the problem with coagulation is less likely to occur and the products can be pasteurized at higher temperature. Examples of pasteurization at high temperature are above 85° C. but below the boiling point for 2-20 minutes, for example 90-95° C. for 2-10 minutes.

Because of the general high salt content in milk permeate concentrate (see Table 5), it is not always necessary to add salt to the final product. The amount of salt added depends primarily on the amount of milk permeate concentrate used, MPC being the primary natural source of salt.

The side-streams can also be designated as by-products.

A side-stream or by-product is a secondary product derived from a manufacturing process meaning that a by-product or side-stream is a product that is not necessarily desired but is a result of the production process. Thereby, it is not the primary product or service being produced, but rather something produced in addition to the principal product in an industrial process.

The milk used to obtain any of the side-streams can derive from raw milk and/or pasteurised milk.

The milk could, in principle, be obtained from any lactating animal, such as cattle, goats, sheep, buffalo, yaks, lamas, camels, donkeys, horses or reindeer. However, most preferred, the milk used in the context of the present disclosure is obtained from cattle, goats, sheep, buffalo, or camels. Preferably, the milk is bovine milk.

A salty yoghurt or yoghurt-like product can be produced using the above described method.

### Buttermilk

One of the basic ingredients of the yoghurt base compositions provided herein is liquid buttermilk and/or buttermilk powder. Buttermilk can be obtained from several types of milk such as cow, water buffalo, goats, ewes, mares, camels, and/or yaks milk. However, bovine milk is preferred.

The buttermilk can be sweet buttermilk, acid buttermilk or cultured buttermilk. Sweet buttermilk is a by-product from churning sweet cream into butter. Acid(ified) buttermilk is made by adding a food-grade acid (such as lemon juice) to milk. Cultured buttermilk is made by pasteurizing and homogenizing milk (with 1% or 2% fat) before inoculating it with a culture of Lactococcus lactis plus Leuconostoc citrovorum to simulate the naturally occurring bacteria in the old-fashioned product.

In a preferred embodiment, the buttermilk composition is sweet buttermilk.

Sweet buttermilk may be a side-stream, which constitutes one ingredient of the salty yoghurt product herein described. Sweet buttermilk may be obtained as a side-stream from production of butter during the churning step in which the fat fraction (butter) is separated from the water fraction (buttermilk).

The buttermilk can be in the form of either a liquid or a solid. The liquid buttermilk can be dried and provided in solid form as a buttermilk powder. The powder may be loose and/or compact powders as well as grains.

The powder can for example be obtained by freeze drying, convection drying, bed drying, drum drying, microwave-vacuum drying, shelf drying, spray drying or infrared-radiation drying the liquid buttermilk.

The buttermilk (liquid or powder) can comprise constituents in the following ranges:

Table 1

The constituents of the milk permeate concentrate (g/100 g). SBM: Sweet Butter Milk. SBMP: Sweet Butter Milk Powder.

| Range | SBM | SBMP |
|---|---|---|
| Fat | 0,6-0,7 | 7,0-7,5 |
| Carbohydrate | 3,7-4,3 | 43-51,4 |
| > Sugar | 3,7-4,3 | 43-51,4 |
| Protein | 2,1-3,6 | 28,3-39,2 |
| > Dairy | 2,1-3,6 | 28,3-39,2 |
| > Non dairy | 0 | 0 |
| Salt | 0,1-0,2 | 1,4-1,8 |

### Whey

Whey is the liquid remaining after milk has been curdled and strained. It is a by-product of the manufacture of cheese or casein and has several commercial uses. Sweet whey is a by-product produced during the manufacture of rennet types of hard cheese, like Cheddar or Swiss cheese. Acid whey (also known as sour whey) is a by-product produced during the making of acid types of dairy products, such as cottage cheese or strained yogurt.

To produce cheese, rennet or an edible acid is added to heated milk. This makes the milk coagulate or curdle, separating the milk solids (curds) from the liquid whey. Sweet whey is the by-product of rennet-coagulated cheese, and acid whey (also called sour whey) is the by-product of acid-coagulated cheese. Sweet whey has a pH greater than or equal to 5.6; acid whey has a pH less than or equal to 5.1.

Whey is left over when milk is coagulated during the process of cheese production and contains everything that is soluble from milk after the pH is dropped to 4.6 during the coagulation process. It is a 5% solution of lactose in water, with some minerals and lactalbumin. Processing can be done by simple drying, or the relative protein content can be increased by removing lipids and other non-protein materials. For example, spray drying after membrane filtration separates the proteins from whey.

In a preferred embodiment, the whey composition is acid whey.

Acid whey is a side-stream, which may be provided as one ingredient of the salty yoghurt product. Acid whey may be obtained as a side-stream from production of cottage cheese, skyr and/or strained yoghurt such as Greek yoghurt, in which acid whey is removed from the main product by drainage or filtration after acidification.

The acid whey can be in the form of either a liquid or a solid. The solid may in form of a powder, such as a loose powder or such as a compact powder.

The powder can for example be obtained by freeze drying, convection drying, bed drying, drum drying, microwave-vacuum drying, shelf drying, spray drying or infrared-radiation drying the liquid acid whey.

The acid whey (AW) can comprise constituents in the following ranges:

Table 2

The constituents of the milk permeate concentrate (g/100 g). AW: Acid Whey.

| Range | AW |
|---|---|
| Fat | 0,02-0,08 |
| Carbohydrate | 3,2-4,2 |
| > Sugar | 3,2-4,2 |
| Protein | 0,7-1,0 |
| > Dairy | 0,7-1,0 |
| > Non dairy | 0 |
| Salt | 0,1-0,2 |

### Milk Permeate

The salty yoghurt or yoghurt-like product comprises milk permeate as one of its ingredients. Milk permeate is obtained as a side-stream from the production of milk protein concentrate, wherein milk is subjected to centrifugation to extract fat and subsequently ultrafiltration to extract protein. The milk permeate has a higher lactose content than regular milk and is therefore sweeter.

Milk Permeate is a by-product of the Milk Protein Concentrate production process, formed after ultrafiltration of milk to extract protein and fat. The product may then be dried using spray drying or other drying techniques. Milk permeate powder is characterized by a clean, slightly salty taste and uniform particle size. It consists of lactose, water, vitamins and minerals and a minor content of protein and fat.

Milk Permeate Powder is a natural food ingredient and is suitable for a wide range of applications including beverages, seasonings, confectionery, soups, sauces, desserts, and bakery.

Milk permeate may be obtained from raw milk, which is subjected to centrifugation to extract fat and ultrafiltration to extract protein, wherein the milk permeate is the remaining composition upon extraction of fat and protein.

The centrifugation and ultrafiltration are performed using methods known to the person of skill in the art.

From the milk permeate, a milk permeate concentrate can derived by reducing the water content further such as by drying.

Both the milk permeate and the milk permeate concentrate can be in the form of either a liquid or a solid.

In one embodiment, the solid is a powder, such as a loose powder or such as a compact powder. The powder can for example be obtained by freeze drying, convection drying, bed drying, drum drying, microwave-vacuum drying, shelf drying, spray drying or infrared-radiation drying the milk permeate or the milk permeate concentrate.

The milk permeate concentrate can comprise constituents in the following ranges:

Table 3

The constituents of the milk permeate concentrate (g/100 g). MPC: MilkPermeate Concentrate.

| Range | MPC |
|---|---|
| Fat | 0,04- 0,07 |
| Carbohydrate | 11,0-14,3 |
| > Sugar | 11,0-14,3 |
| Protein | 0,3-0,5 |
| > Dairy | 0,3-0,5 |
| > Non dairy | 0 |
| Salt | 0,6-0,7 |
| Calcium | 0,1-0,2 |

### Liquids

The method of producing a salty yoghurt or yoghurt-like product may comprise the addition of a liquid. Examples of relevant liquids are water, juice, milk, juice concentrate and milk concentrate.

In one embodiment, the liquid is selected from the group consisting of water, carbonated water, flavored water, carbonated flavored water, juice (juice derived from any fruit or any combination of fruits, juice derived from any vegetable or any combination of vegetables or nectar), drinks containing juice, coffee, decaffeinated coffee, tea, tea from fruit products, tea derived from herb products and/or decaffeinated tea, milk obtained from any animal, milk-derived products such as sweet buttermilk, milk products derived from soy, rice, coconut and/or other plant material, fermented milk products, milk permeate and/or drinking chocolates.

In one embodiment, the liquid is selected from the group consisting of water, carbonated water, flavored water, carbonated flavored water.

In another embodiment, the liquid is selected from the group consisting of milk obtained from any animal, milk-derived products such as sweet buttermilk, milk products derived from soy, rice, coconut or other plant material, fermented milk products and drinking chocolates.

In one embodiment, the liquid is selected from the group consisting of juice (juice derived from any fruit or any combination of fruits or berries, juice derived from any vegetable or any combination of vegetables or nectar) and/or drinks containing juice.

In another embodiment, the liquid is selected from the group consisting of coffee, decaffeinated coffee, tea, tea from fruit products, tea derived from herb products and/or decaffeinated tea.

It is preferred, however, to mix the yoghurt base composition with water or milk.

### Cultures

The fermentation of the salty yoghurt product may be performed using a yoghurt culture.

Fermentation may be performed using yoghurt cultures such as Streptococcus thermophilus and Lactobacillus delbrueckii subsp. bulgaricus, cultures containing Lactobacillus acidophilus and kefir cultures containing lactic acid bacteria species and occasionally yeasts.

The fermentation of the yoghurt base with culture may be performed at temperatures between 20-45° C. until a pH of 3-6 is reached. Subsequently, the mixture may be cooled to a temperature between freezing and 30° C. Preferably, the mixture is cooled to a temperature between 0° C. and 10° C., such as between 2 and 6° C.

The fermentation of the yoghurt base with culture may be performed at temperatures between 20-45° C. until a pH of 3-6 is reached. Afterwards, the mixture can be cooled to a temperature between freezing (0° C.) and 30° C. to stop the fermentation. If a yoghurt culture is used, below 30° C. is sufficient to stop fermentation, whereas for a kefir culture or mesophilic culture it is preferred to go below 10-15° C.

The fermentation is performed at temperatures between 20-45° C., such as 25-45° C., such as 30-45° C., such as 35-45° C., such as 40-45° C., such as 43° C.

The pH reached after fermentation is between pH 3-6, such as between 3.5-5.5, such as between 4-5, such as 4.2-4.7, such as 4.2-4.6, such as pH 4.2-4.5, such pH 4.2-4.4, such pH 4.25-4.35, such as pH 4.3.

The final temperature of the mixture is between 0-30° C.,, such as 0-25° C., such as 0-20° C., such as 0-15° C., such as 0-10° C., such as 1-9° C., such as 2-8° C., such as 3-7° C., such as such as 4-6° C., such as 5° C.

### Salt

A possible additional ingredient of the salty yoghurt is salt. The salt can be sodium chloride (table salt), potassium chloride or sodium glutamate, or a mixture of milk minerals. Typically, the salt level is adjusted to approximately 0.7 g/L but it could also be adjusted to other levels depending on the desired taste characteristics of the final product. Part of the salt comes from the milk permeate concentrate, which contains slightly less than 0.7 g/L of salt.

In a preferred embodiment, the salt is sodium chloride (table salt).

### Additional Ingredients

The salty yoghurt or yoghurt-like product may also include adding one or more additional components. The additional components may serve to optimize the taste, flavour, texture and/or health effects of the final salty yoghurt product.

An additional component could be starch, protein, lipid, emulsifier, stabiliser, colloids, colour, fibre, vitamins, minerals, flavour, carbon dioxide and/or carbonate.

Additional fat, oils, and protein may be present in total amounts up to 5 %, such as up to 0.5, up to 1 or up to 2 or 3 % (w/w) of the final liquid product.

The term “carbon dioxide” (CO₂) as used herein refers to carbon dioxide in its gas state. Carbon dioxide can be added during or after fermentation to introduce carbonation into the product.

The term “lipids” as used herein refers to fat molecules that are soluble in nonpolar solvents. Lipids added to the salty yoghurt product provided herein can be selected from the group consisting of fatty acids, triglycerides, glycerolipids, glycerophospholipids, sphingolipids, saccharolipids, polyketides, sterol lipids such as cholesterol, and prenol lipids. The fatty acids may be either saturated and/or unsaturated.

Starch can be obtained from a number of sources, and in one preferred embodiment, the compositions provided herein comprise starch obtained from potatoes, wheat, maize (corn), rice, and/or cassava. In a preferred embodiment, the starch is refined starch and/or modified starch. The starch may in one preferred embodiment be provided as a powder.

The term fiber used herein refers to a composition of soluble and insoluble fibers selected from the group consisting of short-chain fatty acids, non-starch polysaccharides, beta-glucan and psyllium, cellulose, hemicellulose, resistant starch, resistant dextrins, raffinose, inulin, lignins, chitins, pectins, beta-glucans, fructans, polyuronides, xylose, polydextrose, lactulose, xanthan gum and/or oligosaccharides.

In a preferred embodiment, the fibers comprise exopolysaccharides, galactoligosaccharides, fructooligosaccharides, microcrystalline cellulose and/or carboxymethyl cellulose.

The term “flavour” as used herein refers to a composition comprising natural flavours, artificial flavours and/or flavour enhancers. The natural flavours can be sweetening agents such as sugar and/or high intensity sweeteners or flavours originating from plants.

Artificial flavours can be selected from the group consisting of Diacetyl, acetylpropionyl, acetoin, Isoamyl acetate, Benzaldehyde, Cinnamaldehyde, Ethyl propionate, Methyl anthranilate, Limonene, Ethyl decadienoate, Allyl hexanoate, Ethyl maltol, Ethylvanillin, Methyl salicylate, and Manzanate.

In one embodiment, the flavour is a sweetening agent, such as sugar.

In another embodiment, the flavour is mint and/or parsley.

The term “colour” can be any given food colour or colour additive, such as a natural food colour or artificial food colour. The food colour can be added in any form such as liquids, powders, gels and/or pastes.

The term “colloids” as used herein refers to a mixture in which one substance of microscopically dispersed insoluble particles is suspended throughout another substance. In one embodiment, the colloids are hydrocolloids.

The term “stabilisers” used herein refers to a substance that increases the stability and thickness of the food. An example of a type of stabiliser is e.g. hydrocolloids.

The term “emulsifier” used herein refers to any substance that stabilizes an emulsion by increasing its kinetic stability. Examples of emulsifiers include egg yolk, mustard, soy lecithin, sodium phosphates, sodium stearoyl lactylate, DATEM and mono- and diglycerides.

The term “vitamins” used herein refers to any organic molecule, which functions as an essential micronutrient that an organism needs in small quantities for the proper functioning of its metabolism. Examples of vitamins include Vitamin A, Vitamin D3, Vitamin E, Vitamin C, Vitamin B1, Vitamin B2, Vitamin B6, Vitamin B12, Vitamin K1 and Vitamin K2.

The provided salty yoghurt compositions may also comprise added minerals, such as calcium, iron, magnesium, phosphor, potassium, zinc, copper and/or such as selenium

### A Yoghurt Powder Base Composition

The present invention also provides a yoghurt powder base composition, which comprises milk permeate concentrate and buttermilk in powder form, such as in dry form. The composition may additionally comprise acid whey, cultures, salt and/or any of the above mentioned “additional ingredients” in powder form.

The powder base composition can be prepared centrally at a dairy and be finished by adding liquid and culture or acid and packaged for local sale and consumption.

Thus, in one embodiment, the yoghurt powder base composition comprises milk permeate concentrate, buttermilk and whey in dry form.

In another embodiment, the yoghurt powder base composition comprises milk permeate concentrate, buttermilk, whey and a salt, where the salt can be sodium chloride, potassium chloride or sodium glutamate or a mixture of milk minerals, in dry form.

In a further embodiment, the yoghurt powder base composition also comprises a microbial culture, such as a thermophilic culture, mesophilic culture or a kefir culture, wherein said culture optionally comprises Streptococcus thermophilus and/or Lactobacillus delbrueckii subsp. bulgaricus and optionally other lactic acid bacteria such as from the genera Lactobacillus, Lactococcus, Leuconostoc, Streptococcus and Bifidobacterium, in dry form.

### Salty Yoghurt or Yoghurt-like Product

The salty yoghurt or yoghurt-like product or composition comprises lipid, protein, and carbohydrate. The composition may constitute a spoonable yoghurt or a yoghurt drink. A spoonable yoghurt has a consistency that enables easy consumption by a spoon.

The salty yoghurt or yoghurt-like product may comprise all three side-streams:
a. 10-90 % (w/w) milk permeate concentrate, preferably 10-25 %,
b. 30-60 % (w/w) buttermilk, preferably 50-70%, and
c. 10-40% (w/w) acid whey, preferably 20-30%.

The percentages are based on the wet weight of the three ingredients and are calculated on the basis of the final liquid product. The liquid product may be fermented or soured to form a spoonable yoghurt or a yoghurt drink. In many embodiments, the product is similar in taste and texture to Ayran.

Alternatively, the salty yoghurt or yoghurt-like product may comprise only two of the side-streams:
a. 10-30% milk permeate concentrate, and
b. 50-70% buttermilk.

In one embodiment, the salty yoghurt or yoghurt-like product has a protein content in the range of 0-10%, such as 0-5%, such as 0.05-3%, such as 0.05-2.5%, such as 1-2,5 or 1-2%.

In one embodiment, the salty yoghurt or yoghurt-like product has a carbohydrate content in the range of 0-15%, such as 0-10%, such as 0-5%, such as 1-5%, such as 2-5%, such as 3-5%.

In one embodiment, the salty yogurt or yoghurt-like product has a lipid content in the range of 0-10%, such as 0-5%, such as 0-1%, such as 0.1-1%. The lipid content will typically be below 1%, preferably below 0.5% unless lipid or oil is added from sources other than whey, milk permeate concentrate, and buttermilk. It is a characteristic of the products of the present disclosure that they have a low content of milk fat.

In one embodiment, the salty yogurt or yoghurt-like product has a salt content in the range 0-5%, such as 0-2%, such as 0-1%, such as 0.5-0.7%

In a preferred embodiment, the salty yoghurt or yoghurt-like product comprises less than 0.5% milk fat, 4-5% carbohydrate, 1-2% milk protein and 0.6 to 0.75% salt.

### Items

The disclosure is now described as numbered items starting with number 1.

1. A method of producing a salty yoghurt or yoghurt-like drink, said method comprising combining a milk permeate concentrate, and a buttermilk composition.

2. The method of item 1, further comprising adding a whey composition.

3. The method according to any of the preceding items, wherein said method comprises the steps of
a. obtaining or providing a milk permeate concentrate,
b. obtaining or providing a buttermilk composition, and
c. mixing said milk permeate concentrate, and buttermilk compositions.

4. The method according to any of the preceding items, wherein said method comprises the steps of
a. obtaining or providing a milk permeate concentrate,
b. obtaining or providing a buttermilk composition,
c. obtaining or providing a whey composition, and
d. mixing said milk permeate concentrate, buttermilk and whey compositions.

5. The method according to any of the preceding items, wherein said milk permeate concentrate is obtained from raw milk by the following steps:
a. Centrifuging the raw milk to separate it into a cream fraction and a low-fat milk fraction,
b. Ultrafiltrating said low-fat milk fraction to separate proteins from the low-fat milk fraction, wherein the remaining composition is milk permeate
c. Reducing the water content of said the milk permeate to obtain a milk permeate concentrate.

6. The method according to item 5, wherein said separated proteins are in a liquid composition.

7. The method according to item 5, wherein said milk permeate concentrate is a liquid composition.

8. The method according to item 5, wherein said milk permeate concentrate is a side-stream from the production of dairy proteins, such as casein and whey proteins.

9. The method according to any of the preceding items, wherein said buttermilk is sweet buttermilk obtained by subjecting cream to churning to separate the fat fraction from the liquid phase, wherein the liquid phase is said sweet buttermilk.

10. The method according to any of the preceding items, wherein said whey is acid whey obtained by draining or filtration of a dairy product, such as milk, after acidification.

11. The method according to any of the preceding items, wherein one or more of said milk permeate concentrate, buttermilk and whey compositions are provided in solid form.

12. The method according to any of the preceding items, wherein said method further comprises mixing the solid compositions with a liquid.

13. The method according to item 12, wherein said liquid is water, juice or milk, or concentrates thereof.

14. The method according to any of the preceding items, said method further comprising adding a salt to said mixture.

15. The method according to item 14, wherein said salt is sodium chloride, potassium chloride or sodium glutamate or a mixture of milk minerals.

16. The method according to any preceding items, wherein said milk permeate concentrate has a lactose content of at least 6 g/100 g.

17. The method according to any of the preceding items, said method further comprising adding said microbial culture.

18. The method according to item 17, wherein said microbial culture is a thermophilic culture, mesophilic culture or a kefir culture.

19. The method according to item 18, wherein said culture comprises Streptococcus thermophilus and/or Lactobacillus delbrueckii subsp. bulgaricus and optionally other lactic acid bacteria such as from the genera Lactobacillus, Lactococcus, Leuconostoc, Streptococcus and Bifidobacterium.

20. The method according to item 18, wherein said kefir culture comprises lactic acid bacteria species and optionally yeast species.

21. The method according to any of the preceding items, said method further comprises fermenting said mixture with a microbial culture at a temperature of 20-45° C. until a pH of 4.2-4.6 is reached, followed by cooling the said fermented product to a temperature below 30° C., preferably below 5° C.

22. The method according to any of the preceding items, said method further comprising adding one or more additional ingredients, such as starch, colloids, lipids, sugar, non-sugar sweetening agent, flavor, flavor enhancer, mint, parsley, fruit and fruit extract, vegetable and vegetable extract, emulsifier, protein, carbon dioxide, carbonate and/or fibers.

23. A salty yoghurt or yoghurt-like drink obtainable by a method as defined in any of the preceding items.

24. A salty yoghurt or yoghurt-like drink comprising milk permeate concentrate, and buttermilk.

25. The salty yoghurt or yoghurt-like drink according to item 24, further comprising whey.

26. The salty yoghurt or yoghurt-like drink according to item 24, wherein said salty yoghurt or yoghurt-like drink further comprises a liquid and/or an added salt.

27. The salty yoghurt or yoghurt-like drink according to item 26, wherein said liquid is water, juice and/or milk, or concentrates thereof.

28. The salty yoghurt or yoghurt-like drink according to item 26, wherein said salt is sodium chloride, potassium chloride or sodium glutamate or a mixture of milk minerals.

29. The salty yoghurt or yoghurt-like drink according to items 24 to 28, wherein said salty yoghurt or yoghurt-like drink further comprises a microbial culture, such as defined in items 18 to 20.

30. The salty yoghurt or yoghurt-like drink according to items 23 to 29, wherein said salty yoghurt or yoghurt-like drink is a fermented product.

31. The salty yoghurt or yoghurt-like drink according to any of the preceding items 23 to 30, wherein said yogurt or yoghurt-like drink has a protein content in the range of 0-20%, such as 0-10%, such as 0-5%, such as 0.05-3%, such as 0.05-2%, such as 1-2%.

32. The salty yoghurt or yoghurt-like drink according to any of the preceding items 23 to 31, wherein said yogurt or yoghurt-like drink has a carbohydrate content in the range of 0-15%, such as 0-10%, such as 0-5%, such as 1-5%, such as 2-5%, such as 3-5%.

33. The salty yoghurt or yoghurt-like drink according to any of the preceding items 23 to 32, wherein said yogurt or yoghurt-like drink has a lipid content in the range of 0-10%, such as 0-5%, such as 0-1%, such as 0.1-1%.

34. The salty yoghurt or yoghurt-like drink according to any of the preceding items 23 to 33, wherein said yoghurt or yoghurt-like drink comprises less than 0.5% milk fat, 4-5% carbohydrate, 1-2% milk protein and 0.6 to 0.75% salt.

35. The salty yoghurt or yoghurt-like drink according to any of the preceding items 23 to 34, wherein said yoghurt or yoghurt-like drink comprises one or more additional ingredients.

36. The salty yoghurt or yoghurt-like drink according item 35, wherein said additional ingredient is a mineral, such as calcium, iron, magnesium, phosphor, potassium, zinc, copper and/or selenium.

37. The salty yoghurt or yoghurt-like drink according item 35, wherein said additional ingredients are starch, colloids, lipids, sugars, non-sugar sweeteners, flavors, flavor enhancers, mint, parsley, fruit, fruit extracts, vegetable, vegetable extracts, emulsifiers, proteins, carbon dioxide, carbonate and/or fibers.

38. The salty yoghurt or yoghurt-like drink according to any of the preceding items 23-37, comprising
a. 10-90 % (w/w) milk permeate concentrate, preferably 10-25 %,
b. 30-60 % (w/w) buttermilk, preferably 50-70%, and
c. 10-40% (w/w) acid whey, preferably 20-30%, or
a. 10-30% milk permeate concentrate, and
b. 50-70% buttermilk.

### EXAMPLES

The invention is now described with reference to specific examples.

A general method of making the salty yoghurt herein described includes mixing the side-streams SBM (SBMP), MPC and AW with water and salt. After homogenisation and pasteurisation, the base may be fermented with a yoghurt culture and subsequently the yoghurt product may be smoothened and filled. Examples of a final composition for salty yoghurt product herein described comprising either Sweet Buttermilk (SBM) or Sweet Buttermilk Powder (SBMP) can be found in Table 4 as Type 1 and Type 2, respectively. As an alternative to SBM or SBMP, it is furthermore possible to apply equal amounts of skim milk or skim milk powder.

Table 4

Content and composition of Arla’s Bizim Ayran and the salty yoghurt as herein described based on sweet buttermilk (SBM), sweet buttermilk powder (SBMP), acid whey (AW) and milk permeate concentrate (MPC).

| | | Bizim Ayran | Type 1 - SBM | Type 2 - SBMP |
|---|---|---|---|---|
| Content | Milk | 60 | | |
| | Water/whey | 39,3 | | |
| | Salt | 0,7 | 0,51 | 0,51 |
| | SBM | | 47 | |
| | SBMP | | | 4 |
| | MPC | | 15,5 | 15,5 |
| | Acid whey | | 20 | 20 |
| | Water | | 16,99 | 59,99 |
| Composition | fat | 2,1 | 0,31 | 0,31 |
| | sugar | 2,6 | 4,59 | 4,59 |
| | protein | 2 | 1,57 | 1,57 |
| | salt | 0,7 | 0,70 | 0,70 |
| | water | 92,6 | 91,97 | 91,97 |

### Example 1

In one example, we prepare a salty yoghurt product from dairy side-streams as follows, making sure that the sensory characteristics (sweetness, saltiness, acidity, mouthfeel) are similar to a reference Ayran (Arla’s Bizim Ayran) made from yoghurt, water, salt and a minor fraction of whey. This reference ayran contains 2.1% milk fat, 2.6% milk sugar, 2% milk protein and 0.7% salt (Table 5).

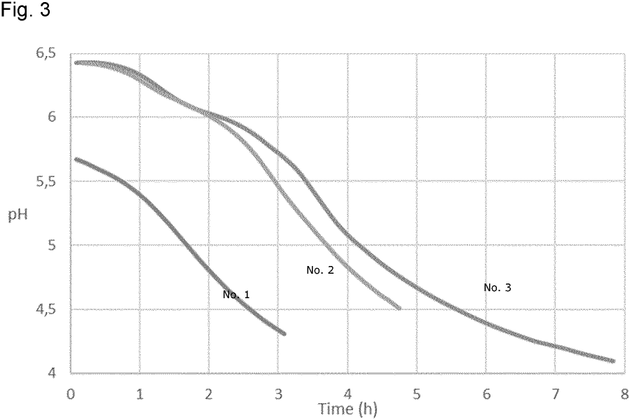

Per 100 g of final product, 15.5 g Milk Permeate Concentrate (MPC), 47 g Sweet Buttermilk (SBM), 0.51 sodium chloride (salt) or iodized salt, and 16.99 g water are mixed, whereafter 20 g Acid Whey (AW) is blended in. Addition of other ingredients is optional. The blend is homogenized and mildly pasteurized (70-75° C. for 10-20 min) before being tempered to a temperature that supports growth of a starter culture (30-45° C.). The here used starter culture is a high (post-)acidifying yoghurt culture, Yo-flex YC-470 (Chr. Hansen), with 0.02% inoculation rate. Fermentation continues until a pH of 4.3 is reached (FIG. 3), where after the product is cooled to a temperature that does not support further fermentation (<30° C.). The resulting nutritional composition is depicted in Table 5.

The following examples follow a similar process unless stated otherwise. The final product will be similar in sweetness, saltiness, acidity as the reference Ayran (Arla’s Bizim Ayran), but the mouthfeel may give lower perceived creaminess and viscosity due to the lower fat and protein contents.

### Example 2

Instead of SBM, the solid version of this side-stream (Sweet Buttermilk Powder or SBMP) can be used. As 100 g of the here used SBM contains about 8.5 g solids, 47 g SBM can be replaced for 4 g SBMP and 43 g water to obtain a similar composition. Thus, the composition and characteristics of the product made in this example are similar to that one made in Example 1 (FIG. 2). In the following examples, SBM and SBMP can be used interchangably in the correct ratio without affecting compositions and characteristics of the products.

### Example 3

A more acidic ayran product can be obtained by increasing the fraction of AW, in this example from 20 g/100 g to 30 g/100 g, and reducing the fraction of SBM compared to Example 1, in this example from 47 g/100 g to 35.25 g/100 g (Table 5). This results in a product with less fat, sugar and protein thus with clear lower sweetness and higher acidity than that of Example 1 and the reference Ayran, whereas saltiness is similar and the mouthfeel may be perceived with slightly reduced creaminess and viscosity.

### Example 4

A second way to obtain higher acidity is through extended fermentation, as many yoghurt cultures including Yo-flex YC-470 have the ability to acidify to pH 4 or even below. Here, AW can be reduced or even omitted. Omission of AW allows pasteurization at temperatures normally used for milk base for yoghurt and like products (90-95° C. for 5 min). Here, 20 g MPC, 58.75 g SBM, 0.49 g salt and 20.76 g water are mixed (Table 5) and pasteurized before fermentation to pH 4.1 (FIG. 3). This results in a product with more fat, sugar and protein than that of Example 1, though less than the reference Ayran. The increased sweetness is not perceived due to the higher acidity, whereas saltiness is similar and the mouthfeel may be perceived with slightly increased creaminess and viscosity compared to Example 1.

### Example 5

To have a less acidic product, one can lower the amount of AW or omit it, in combination with using a milder yoghurt culture, such as Yo-flex Mild 1.0, or — as in this example — using another type of starter culture such as the kefir culture Dairyland Direct KM-1 (DSM). Here the formulation and process are the same as in Example 4, but the culture is different and the fermentation is stopped at pH 4.5 (FIG. 3). The characteristics of the product are similar to that of the one made in the fourth example, except that the acidity is lower and, hence, the perceived sweetness a bit higher. In addition, kefir cultures produce carbonate, creating sparkle in the product. If sparkle is a desired product characteristic, any of the recipes could also be followed by carbonation by adding carbon dioxide gas to the otherwise finished product.

### Example 6

For a very sweet product, the use of MPC should be maximized and therefore it is preferable to use SBMP instead of SBM and minimize the use of AW. For this example, we mix 84 g MPC, 5 g SBMP, a minor amount of 0.07 g salt (a similar amount comes from SBMP and 0.55 g comes from MPC) and 10.93 g water per 100 g product (Table 5). Compared to the first example, there is a bit more fat, a lot more milk sugar (~13 g/100 g), a similar amount of salt and a bit higher amount of protein, that is the same amount as in the reference Ayran. The resulting product is very much like the reference ayran, except that the sweetness is much higher due to the high sugar content and the creaminess is lower due to the lower fat content.

### Example 7

All previous examples have relatively low fat contents and, hence, lower creaminess than the reference Ayran. This can be compensated by addition of milk fat. In this example, to the same formulation as in Example 1, 2.21 g/100 g butter containing 81% fat is added to raise the total fat level to a similar level as the reference Ayran, that is 2.1 g/100 g fat (Table 5). The product is very similar in sensory characteristics as the reference Ayran and it is creamier than the product of the first example.

### Example 8

Instead of adding milk fat to increase the fat level of a formulation such as in Example 7, vegetable fat such as rapeseed oil, sunflower oil, olive oil and coconut fat can be used as cheaper solution. In this example, to the same formulation as in Example 1, 1.79 g/100 g rapeseed oil is added to raise the total fat level to a similar level as the reference ayran, that is 2.1 g/100 g fat (Table 5). The product is very similar in sensory characteristics as Example 7 and the reference ayran and it is creamier than the product of Example 1. Some vegetable fats may influence the colour and flavour of the finished product.

### Example 9

In order to increase the protein level of the product made in the first example to the level of the reference ayran, it is possible to add a dairy or non-dairy protein ingredient, such as whey protein isolates, caseinates and vegetable protein extracts such as from pea, lupin and potato. In this example, the formulation as in Example 1 is modified slightly by the addition of 0.54 g/100 g pea protein isolate (Bulk Powders) containing 80% protein, 6% fat and 3% carbohydrate as well as lowering the salt addition from 0.51 g/100 g to 0.5 g/100 g to compensate for the salt added through the protein ingredient (Table 5). The product is very similar in sensory characteristics as the reference ayran and it has higher viscosity than the product of Example 1. Some vegetable protein ingredients may influence the colour and flavour of the finished product.

Table 5

Nutritional compositions of a reference Ayran (Arla’s Bizim Ayran), single ingredients used for the examples and of nine examples of Ayran containing milk permeate concentrate, sweet buttermilk (powder) and optionally acid whey (g/100g). MPC: milk permeate concentrate. SBM: sweet buttermilk. SBMP: sweet buttermilk powder. AW: acid whey.

| | Single ingredients | | | | | | | | | |
|---|---|---|---|---|---|---|---|---|---|---|
| | MPC | SBM | SBMP | AW | | Salt | Butter | oil Rapeseed | | Pea protein |
| MPC | 100 | | | | | | | | | |
| SBM | | 100 | | | | | | | | |
| SBMP | | | | 100 | | | | | | |
| AW | | | | | 100 | | | | | |
| Salt | | | | | | 100 | | | | |
| Milk fat | | | | | | | 100 | | | |
| Vegetable oil vegetable protein | | | | | | | | | 100 | 100 |
| Fat | 0,05 | 0,625 | 7,268 | | 0,05 | 0 | 81 | | 100 | 6 |
| Carbohydrate | 12,66 | 4,01 | 47,186 | | 3,72 | 0 | 0,1 | | 0 | 3 |
| > Sugar | 12,66 | 4,01 | 47,186 | | 3,72 | 0 | 0,1 | | 0 | 0,1 |
| Protein | 0,39 | 2,885 | 33,763 | | 0,82 | 0 | 0,9 | | 0 | 80 |
| > Dairy | 0,39 | 2,885 | 33,763 | | 0,82 | 0 | 0,9 | | 0 | 0 |
| > Non dairy | 0 | 0 | 0 | | 0 | 0 | 0 | | 0 | 80 |
| Salt | 0,65 | 0,145 | 1,641 | | 0,14 | 100 | 0,022 | | 0 | 1,9 |
| | Bizim ayran | Ex 1 | Ex 2 | Ex 3 | Ex 4 | Ex 5 | Ex 6 | Ex 7 | Ex 8 | Ex 9 |
| MPC | | 15,5 | 15,5 | 15 | 20 | 20 | 84 | 15,5 | 15,5 | 15,5 |
| SBM | | 47 | | 35,25 | 58,75 | 58,75 | | 47 | 47 | 47 |
| SBMP | | | 4 | | | | 5 | | | |
| AW | | 20 | 20 | 30 | | | | 20 | 20 | 20 |
| Salt | | 0,51 | 0,51 | 0,511 | 0,488 | 0,488 | 0,072 | 0,51 | 0,51 | 0,5 |
| Milk fat | | | | | | | | 2,21 | | |
| Vegetable oil | | | | | | | | | 1,79 | |
| Vegetable protein | | | | | | | | | | 0,538 |
| Fat | 2,1 | 0,31 | 0,31 | 0,241 | 0,373 | 0,373 | 0,405 | 2,100 | 2,1 | 0,342 |
| Carbohydr. | 2,6 | 4,59 | 4,59 | 4,431 | 4,891 | 4,891 | 12,994 | 4,592 | 4,59 | 4,606 |
| > Sugar | 2,6 | 4,59 | 4,59 | 4,431 | 4,891 | 4,891 | 12,994 | 4,592 | 4,59 | 4,591 |
| Protein | 2 | 1,57 | 1,57 | 1,317 | 1,766 | 1,766 | 2,016 | 1,590 | 1,57 | 2 |
| > Dairy | 2 | 1,57 | 1,57 | 1,317 | 1,766 | 1,766 | 2,016 | 1,590 | 1,57 | 1,57 |
| > Non dairy | 0 | 0 | 0 | 0 | 0 | 0 | 0 | 0 | 0 | 0,43 |
| Salt | 0,7 | 0,7 | 0,7 | 0,7 | 0,7 | 0,7 | 0,7 | 0,7 | 0,7 | 0,7 |

1. A method of producing a salty yoghurt or yoghurt-like product, said method comprising combining a milk permeate concentrate, and a buttermilk composition, followed by fermentation or souring.

2-21. (canceled)

22. The method of claim 1, wherein the buttermilk composition is a sweet buttermilk composition.

23. The method according to claim 1, further comprising adding a whey composition.

24. The method according to claim 23, wherein the whey composition is an acid whey composition.

25. The method according to claim 24, wherein the milk permeate concentrate and sweet buttermilk are mixed prior to addition of acid whey.

26. The method according to claim 1, wherein the product is subject to mild pasteurization at a temperature above 70° C.

27. The method according to claim 1, wherein the product is subject to pasteurization at a temperature between 85° C. and the boiling point for 2-20 minutes.

28. The method according to claim 1, wherein one or more of said milk permeate concentrate, buttermilk or whey compositions are provided in dry form.

29. The method according to claim 1, said method further comprising adding a salt to said mixture.

30. The method according to claim 1, said method further comprising adding a microbial culture, wherein said microbial culture optionally comprises a thermophilic culture, a mesophilic culture, a kefir culture, a lactic acid bacteria, Streptococcus thermophilus, Lactobacillus delbrueckii subsp., bulgaricus, Lactobacillus, Lactococcus, Leuconostoc, Streptococcus or Bifidobacterium.

31. The method according to claim 1, said method comprises fermenting at a temperature of 20-45° C. until a pH of 4.2-4.6 is reached, followed by cooling the said fermented product to a temperature below 30° C.

32. The method according to claim 1, wherein said method produces a salty yoghurt or yoghurt-like product comprising:
a. 10-90 % (w/w) milk permeate concentrate,
b. 30-60 % (w/w) sweet buttermilk, and
c. 10-40% (w/w) acid whey or
a. 10-30% (w/w) milk permeate concentrate, and
b. 50-70% (w/w) buttermilk.

33. The method according to claim 1, wherein said method produces a yoghurt or yoghurt-like product comprising less than 0.5% milk fat, 4-5% carbohydrate, 1-2% milk protein and 0.6 to 0.75% salt.

34. A salty yoghurt or yoghurt-like product comprising milk permeate concentrate, and buttermilk.

35. The salty yoghurt or yoghurt-like product according to claim 32, further comprising whey.

36. The salty yoghurt or yoghurt-like product according to claim 32, comprising
a. 10-90 % (w/w) milk permeate concentrate,
b. 30-60 % (w/w) sweet buttermilk, and
c. 10-40% (w/w) acid whey, or
a. 10-30% (w/w) milk permeate concentrate, and
b. 50-70% (w/w) buttermilk.

37. The salty yoghurt or yoghurt-like product according to claim 32, wherein said product further comprises a liquid and/or an added salt.

38. The salty yoghurt or yoghurt-like product according to claim 32, wherein said product further comprises a microbial culture.

39. The salty yoghurt or yoghurt-like product according to claim 32, wherein said product comprises less than 0.5% milk fat, 4-5% carbohydrate, 1-2% milk protein and 0.6 to 0.75% salt.

40. A yoghurt powder base composition comprising milk permeate concentrate and buttermilk in dry form.

41. The yoghurt powder base composition according to claim 40, further comprising a whey composition.

42. The yoghurt powder base composition according to claim 40, further comprising a salt.

43. The yoghurt powder base composition according to claim 40, further comprising a microbial culture, optionally a thermophilic culture, a mesophilic culture, kefir grains, a lactic acid bacteria, Streptococcus thermophilus,Lactobacillus delbrueckii subsp., bulgaricus, Lactobacillus, Lactococcus, Leuconostoc, Streptococcus or Bifidobacterium in a dry form.
